(19) United States
(12) Patent Application Publication
(10) Pub. No.: US 2006/0279194 A1
(43) Pub. Date: Dec. 14, 2006

(54) Color cathode-ray tube

(75) Inventors: Shinichi Arita, Osaka (JP); Hideaki Eto, Osaka (JP); Hiroshi Sakurai, Osaka (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-Shi (JP)

(21) Appl. No.: 11/417,600

(22) Filed: May 4, 2006

(30) Foreign Application Priority Data
Jun. 13, 2005 (JP) 2005-172547

(51) Int. Cl. H01J 29/80

(52) U.S. Cl. 313/403

(57) ABSTRACT

A substantially rectangular shadow mask in a dome shape includes a plurality of tie-bands with a longitudinal direction thereof being a short-side direction of the shadow mask, a plurality of bridges connecting the tie-bands adjacent to each other in a long-side direction of the shadow mask, and a plurality of electron beam passage apertures formed between the tie-bands. In a region sandwiched by a pair of straight lines parallel to the long-side direction, which respectively pass through a pair of the bridges adjacent to each other in the short-side direction, on a surface of the tie-band on a side opposed to a panel, a plurality of non-through concave portions are formed. Consequently, color displacement caused by heat doming of the shadow mask can be suppressed.

### BACKGROUND OF THE INVENTION

1. Field of the Invention

The present invention relates to a color cathode-ray tube having a shadow mask.

2. Description of Related Art

FIG. 11 is a cross-sectional view showing a schematic configuration of a general color cathode-ray tube. The color cathode-ray tube includes an envelope 3 in which a panel 1 and a funnel 2 are connected to each other. On an inner surface of the panel 1, a phosphor screen 9 is formed, which is coated with phosphors of respective colors of red, green, and blue in a stripe shape or a dot shape. A shadow mask 10 is held by a frame 8 attached to an inner wall surface of the panel 1 so as to be opposed to the phosphor screen 9. A neck 2a of the funnel 2 houses an electron gun 4 emitting three electron beams 5 corresponding to the respective colors of red, green, and blue. A magnetic shield 7 shielding the electron beams 5 from an external magnetic field is attached to the frame 8. A deflection yoke 6 is mounted on an outer circumferential surface of the funnel 2 of the color cathode-ray tube as described above, whereby a color cathode-ray tube apparatus is configured. The three electron beams 5 emitted from the electron gun 4 are deflected in horizontal and vertical directions by the deflection yoke 6, pass through an internal space of the magnetic shield 7 and electron beam passage apertures formed on the shadow mask 10 successively, and strike the phosphors of the respective colors of the phosphor screen 9 to allow them to emit light. Thus, a color image is displayed in a useful display region of the panel 1.

FIG. 12 is a schematic perspective view of a shadow mask structure composed of the shadow mask 10 and the frame 8 in a substantially rectangular frame shape holding the shadow mask 10. The substantially rectangular shadow mask 10 is composed of a thin metal plate, and includes a perforated region 11 in a substantially rectangular shape in which a number of slot-shaped or dot-shaped electron beam passage apertures 21 are provided, and a non-perforated region 12 placed on an outer periphery of the perforated region 11. A principal plane composed of the perforated region 11 and the non-perforated region 12 has a dome-shaped curved surface that protrudes toward the panel 1 side by press forming of a thin metal plate using a die. For convenience of the description, as shown, it is assumed that a long-side direction axis of the shadow mask 10 is an X-axis, a short-side direction axis thereof is a Y-axis, and a tube axis of the cathode-ray tube is a Z-axis. It also is assumed that the direction directed from the electron gun 4 to the panel 1 is the positive direction of the Z-axis.

By the time the electron beams 5 emitted from the electron gun 4 strike the phosphor screen 9, about 80% of the electron beams 5 strike the shadow mask 10, and the kinetic energy of the electrons is converted to heat energy, whereby the shadow mask 10 is heated. Thus, the shadow mask 10 thermally expands wholly or locally (hereinafter, this phenomenon will be referred to as “heat doming”). Because of the thermal expansion of the shadow mask 10, the relative position of the electron beam passage apertures 21 with respect to the phosphors of the respective colors of the phosphor screen 9 changes. Therefore, the three electron beams 5 do not strike the corresponding phosphors correctly, which causes so-called color displacement.

In order to prevent such color displacement, it is effective to suppress the heat doming amount of the shadow mask 10.

For example, JP 2000-100341 A describes that a number of semi-spherical concave portions are formed in a region between the electron beam passage apertures 21 adjacent to each other in the horizontal direction, on a surface of the perforated region 11 of the shadow mask 10 on the electron gun 4 side. The surface area of the perforated region 11 is enlarged by providing a number of concave portions, so that the heat radiation amount from the perforated region 11 increases. Thus, the heat doming amount can be reduced by decreasing the temperature of the shadow mask 10.

Furthermore, JP 62(1987)-283526 A describes that an electron-reflecting coating is formed on a surface of the shadow mask 10 on the electron gun 4 side by spraying a slurry containing bismuth trioxide (Bi₂O₃). Since the electron-reflecting coating reflects the electrons that strike the shadow mask 10, the heat energy absorption amount of the shadow mask 10 decreases. Thus, the heat doming amount can be reduced by suppressing the increase in temperature of the shadow mask 10.

However, when the slurry described in JP 62(1987)-283526 A is sprayed onto the surface of the shadow mask 10 on the electron gun 4 side, where a number of semi-spherical concave portions described in JP 2000-100341 A are formed, it is difficult to allow a coating material to spread sufficiently into the concave portions. Thus, the electron-reflecting coating is not formed sufficiently in the concave portions. Consequently, compared with the shadow mask 10 without the concave portions, in the shadow mask 10 with concave portions, the effect of reducing the heat doming amount obtained by forming the electron-reflecting coating becomes smaller.

### SUMMARY OF THE INVENTION

Therefore, with the foregoing in mind, it is an object of the present invention to provide a color cathode-ray tube in which, in the case where an electron-reflecting coating is formed, the effect thereof can be obtained sufficiently irrespective of the presence of a number of concave potions, whereby the problem of color displacement caused by heat doming can be alleviated.

A color cathode-ray tube of the present invention includes: a panel; a funnel connected to the panel; an electron gun provided in a neck of the funnel; and a substantially rectangular shadow mask in a dome shape provided so as to be opposed to an inner surface of the panel. The shadow mask has a plurality of tie-bands with a longitudinal direction thereof being a short-side direction of the shadow mask, a plurality of bridges connecting the tie-bands adjacent to each other in a long-side direction of the shadow mask, and a plurality of electron beam passage apertures formed between the tie-bands adjacent to each other in the long-side direction.

In a first color cathode-ray tube, in a region sandwiched by a pair of straight lines parallel to the long-side direction, which respectively pass through a pair of the bridges adjacent to each other in the short-side direction, on a surface of the tie-band on a side opposed to the panel, a plurality of non-through concave portions are formed.

In a second color cathode-ray tube, in a region sandwiched by a pair of straight lines parallel to the long-side direction, which respectively pass through a pair of the bridges adjacent to each other in the short-side direction, on a surface of the tie-band on a side opposed to the electron gun, a plurality of non-through concave portions are formed. A depth of the concave portion is larger at a position in a vicinity of an end on the electron beam passage aperture side in the concave portion, compared with a depth at a position in a vicinity of an end on a center side of the tie-band in the concave portion, in the long-side direction.

### BRIEF DESCRIPTION OF THE DRAWINGS

FIG. 1 is a partially enlarged front view of a shadow mask of a color cathode-ray tube according to Embodiment 1 of the present invention, when seen from a panel side.

FIG. 2 is a partially enlarged end view of the shadow mask of the color cathode-ray tube according to Embodiment 1 of the present invention on a surface parallel to a long-side direction.

FIG. 3 is a partially enlarged front view of another shadow mask of the color cathode-ray tube according to Embodiment 1 of the present invention, when seen from the panel side.

FIG. 4 is a front view showing a display pattern used in an experiment for confirming the effects of the color cathode-ray tube according to Embodiment 1 of the present invention.

FIG. 5 is a partially enlarged front view of still another shadow mask of the color cathode-ray tube according to Embodiment 1 of the present invention, when seen from the panel side.

FIG. 6 is a partially enlarged front view of a shadow mask of a color cathode-ray tube according to Embodiment 2 of the present invention, when seen from an electron gun side.

FIG. 7 is a partially enlarged end view of the shadow mask of the color cathode-ray tube according to Embodiment 2 of the present invention on a surface parallel to a long-side direction.

FIG. 8 is a partially enlarged front view of a shadow mask according to one example corresponding to Embodiment 2 of the present invention, when seen from an electron gun side.

FIG. 9 is a partially enlarged front view of another shadow mask of the color cathode-ray tube according to Embodiment 2 of the present invention, when seen from the electron gun side.

FIG. 10 is a partially enlarged front view of still another shadow mask of the color cathode-ray tube according to Embodiment 2 of the present invention, when seen from the electron gun side.

FIG. 11 is a cross-sectional view showing a schematic configuration of a general color cathode-ray tube.

FIG. 12 is a perspective view of a shadow mask structure of the general color cathode-ray tube.

### DETAILED DESCRIPTION OF THE INVENTION

According to the present invention, a plurality of concave portions are formed on a shadow mask, whereby the surface area of the shadow mask is enlarged. Furthermore, in the case of forming an electron-reflecting coating on a surface of the shadow mask on a side opposed to an electron gun, the effect thereof can be obtained sufficiently. Thus, in the shadow mask, the increase in heat radiation amount ascribed to the enlargement in surface area and the decrease in absorption amount of heat energy ascribed to the electron reflection can be performed, whereby the problem of color displacement caused by heat doming can be alleviated.

In the first and second color cathode-ray tubes of the present invention, in a region of a tie-band sandwiched by a pair of straight lines parallel to a long-side direction, which respectively pass through a pair of bridges adjacent to each other in a short-side direction, a plurality of non-through concave portions are formed. In the case where only one concave portion is formed in the above-mentioned region, and the concave portion is small when seen from a direction normal to a shadow mask, the effect of enlarging the surface area of the shadow mask becomes small, which makes it difficult to solve the problem of color displacement caused by heat doming. On the other hand, in the case where only one concave portion is formed in the above-mentioned region, and the concave portion is large when seen from the direction normal to the shadow mask, when the concave portion is formed by half etching, the concave portion becomes deep, and the effective thickness of the shadow mask becomes small. Therefore, the heat conductivity of the shadow mask decreases, which also makes it difficult to solve the problem of color displacement caused by heat doming. In the case of forming a plurality of concave portions in the above-mentioned region, the positive effect of enlarging the surface area of the shadow mask and the negative effect of decreasing the heat conductivity, with respect to the reduction in a heat doming amount, balance each other out appropriately, whereby the effect of reducing a heat doming amount can be obtained as a whole.

In the first color cathode-ray tube of the present invention, concave portions are formed on a surface of a tie-band on a side opposed to a panel. More specifically, it is not necessary to provide the concave portions on a surface on a side opposed to an electron gun. Thus, an effective electron-reflecting coating can be formed while the surface area of the shadow mask is enlarged.

In the first color cathode-ray tube of the present invention, it is preferable that the concave portions are arranged regularly in the long-side direction and/or the short-side direction. According to this configuration, the surface area of the shadow mask can be enlarged efficiently.

Assuming that a depth of a deepest part of the concave portion is D1, and a thickness of the shadow mask is T, it is preferable that a relationship: 0.015 [mm]<D1<T/2 is satisfied. If 0.015 [mm]≧D1 is satisfied, the effect of enlarging the surface area of the shadow mask decreases, so that the effect of solving the problem of color displacement caused by heat doming is small, and it is difficult to form such a small concave portion stably. If D1≧T/2 is satisfied, although the surface area of the shadow mask can be enlarged by 10% or more, the heat conductivity in the short-side direction concurrently is degraded by 50% or more. Thus, compared with the positive effect of enlarging the surface area of the shadow mask with respect to the reduction in a heat doming amount, the negative effect of decreasing the heat conductivity becomes larger; consequently, the heat doming amount of the shadow mask cannot be reduced, which makes it difficult to solve the problem of color displacement.

It is preferable that the concave portion has a substantially semi-spherical shape. Such a concave portion can be formed easily by, for example, half etching.

It is assumed that a width of the tie-band in the long-side direction is TB, a diameter of the concave portion is φ1, and a distance between the two concave portions closest to each other is S. It is preferable that a number n of the concave portions arranged in the long-side direction in the tie-band is a maximum natural number satisfying n≦(TB−S)/(φ1+S). It is preferable that a distance L1 between an end of the tie-band in the long-side direction and a center of the concave portion closest to the end substantially satisfies a relationship: L1=S+φ½. It is preferable that a distance L2 between centers of the concave portions adjacent to each other in the long-side direction substantially satisfies a relationship: L2=(TB−φ1−2S)/(n−0.5) when (TB−φ1−2S)/(n−0.5)−φ1−S≧0 is satisfied, and substantially satisfies a relationship: L2=φ1+S when (TB−φ1−2S)/(n−0.5)−φ1−S<0 is satisfied. It is preferable that a distance L3 between centers of the two concave portions whose positions in the short-side direction are different and which are closest to each other, and a distance L4 thereof in the long-side direction substantially satisfy relationships: L3=φ1+S and L4=TB−2S−φ1−L2 (n−1). According to this configuration, in each tie-band, the number of the concave portions arranged in the long-side direction becomes constant irrespective of the position in the short-side direction, and the pitch of the concave portions in the short-side direction becomes minimum. Thus, the concave portions can be arranged at the highest density, so that the surface area of the shadow mask can be enlarged efficiently.

In the above description, the phrase “substantially satisfy” means that an error within ±0.015 mm is admitted, considering the variation in terms of production.

In the second color cathode-ray tube of the present invention, on a surface of the tie-band on a side opposed to the electron gun, a plurality of concave portions are formed, and a depth of the concave portion is larger at a position in a vicinity of an end on the electron beam passage aperture side in the concave portion, compared with a depth at a position in a vicinity of an end on a center side of the tie-band in the concave portion, in the long-side direction. According to this configuration, the following effect is obtained. In the case of forming an electron-reflecting coating by a spray coating method on the surface on the side opposed to the electron gun where the concave portions are formed, in general, as the depth of the concave portion is smaller, a coating material is more likely to be applied even in the concave portion. However, with the shallow concave portion, the surface area of the shadow mask is not so enlarged. According to the present invention, the following fact is paid attention to: an air stream during spraying flows from the center of a tie-band to each side end thereof (electron beam passage aperture side) in the long-side direction. When the depth of the concave portion is small at the area around the center of the tie-band, which is an upstream side of an air stream, and large at the area around each side end of the tie-band, which is a downstream side, a coating material becomes likely to be applied even in the concave portion. Thus, an effective electron-reflecting coating can be formed while the surface area of the shadow mask is enlarged.

In the second color cathode-ray tube of the present invention, it is preferable that the concave portion is not formed at a position adjacent to the bridge in the long-side direction. An air stream during spraying flows as described above; however, if there is a bridge, the air stream is weakened on an upstream side of the bridge. Thus, when the concave portion is formed at a position on an upstream side of an air stream with respect to the bridge, it becomes difficult to apply a coating material into that concave portion. Thus, a larger effect of reducing a heat doming amount can be obtained by forming an effective electron-reflecting coating at a position adjacent to the bridge, rather than forming a concave portion in which a coating material is not applied at this position.

Furthermore, it is preferable that the concave portions are arranged regularly in the long-side direction and/or the short-side direction. According to this configuration, the surface area of the shadow mask can be enlarged efficiently.

Furthermore, it is preferable that the concave portion is placed with a major axis direction thereof matched with the long-side direction, and a depth of the concave portion becomes larger gradually from the position in the vicinity of the end on the center side of the tie-band in the concave portion to the position in the vicinity of the end on the electron beam passage aperture side in the concave portion, in the long-side direction. According to this configuration, the major axis of the concave portion becomes substantially parallel to an air stream direction during spraying. Then, there is no unevenness on a bottom part of the concave portion, and the depth of the concave portion becomes larger gradually in an air stream direction. Therefore, a coating material becomes more likely to be applied in the concave portion. This further enhances the reflection characteristics of electrons.

Furthermore, assuming that a depth of a deepest part of the concave portion is D2, and a thickness of the shadow mask is T, it is preferable that a relationship: D2<T/2 is satisfied. If D2≧T/2 is satisfied, although the surface area of the shadow mask can be enlarged by 10% or more, the heat conductivity in the short-side direction concurrently is degraded by 50% or more. Thus, compared with the positive effect of enlarging the surface area of the shadow mask with respect to the reduction in a heat doming amount, the negative effect of decreasing the heat conductivity becomes larger; consequently, the heat doming amount of the shadow mask cannot be reduced, which makes it difficult to solve the problem of color displacement.

Furthermore, it is preferable that a width of the concave portion in the short-side direction is larger at the position in the vicinity of the end on the electron beam passage aperture side in the concave portion, compared with a width at the position in the vicinity of the end on the center side of the tie-band in the concave portion, in the long-side direction. According to this configuration, the width of the concave portion in the short-side direction becomes larger gradually in an air stream direction during spraying, so that a coating material becomes more likely to be applied into the concave portion. This further enhances the reflection characteristics of electrons.

In the first color cathode-ray tube of the present invention, it is preferable that a plurality of non-through second concave portions are formed in a region sandwiched by a pair of straight lines parallel to the long-side direction, which respectively pass through a pair of the bridges adjacent to each other in the short-side direction, on a surface of the tie-band on a side opposed to the electron gun. In this case, it is preferable that a depth of the second concave portion is larger at a position in a vicinity of an end on the electron beam passage aperture side in the second concave portion, compared with a depth at a position in a vicinity of an end on a center side of the tie-band in the second concave portion, in the long-side direction. More specifically, it is preferable that, in the first color cathode-ray tube of the present invention in which the concave portions are formed on a surface of the tie-band on a side opposed to the panel, the second concave portions similar to the concave portions of the second color cathode-ray tube of the present invention are formed on a surface of the tie-band on a side opposed to the electron gun. This further can enlarge the surface area of the shadow mask.

In the first and second color cathode-ray tubes of the present invention, it is preferable that an electron-reflecting coating is formed on a surface of the shadow mask on a side opposed to the electron gun. According to this configuration, the electron reflection amount of the shadow mask increases, so that the increase in temperature of the shadow mask is suppressed, which can reduce a heat doming amount. Herein, although there is no particular limit to the electron-reflecting coating, it generally is effective to use a substance with a large atomic weight as an oxide, and a specific example includes a film formed by mixing oxide particles of lead, bismuth, or the like with a binder such as water glass, followed by coating.

It is preferable that the shadow mask is made of a material containing Fe as a main component. According to this configuration, a material cost can be reduced. Herein, “containing Fe as a main component” means containing Fe in an amount of 50% or more.

Hereinafter, the present invention will be described in more detail by way of embodiments.

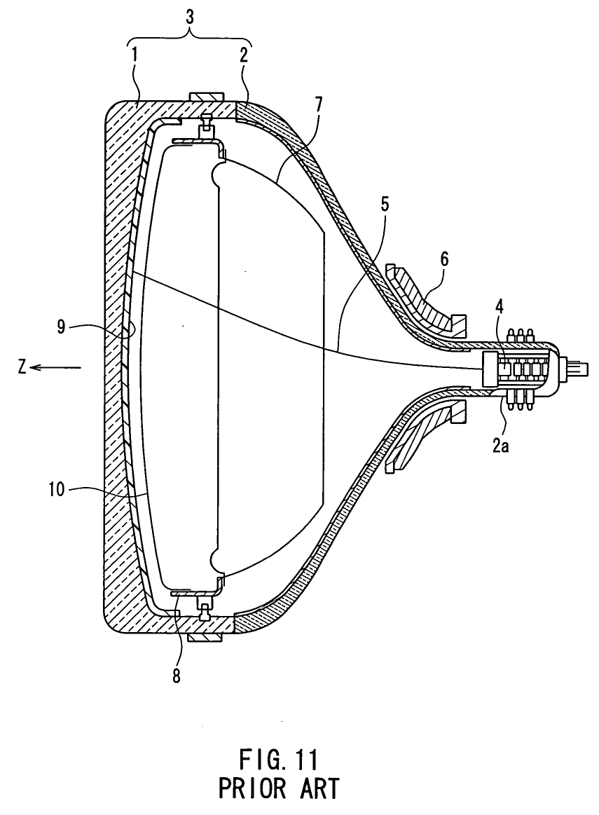

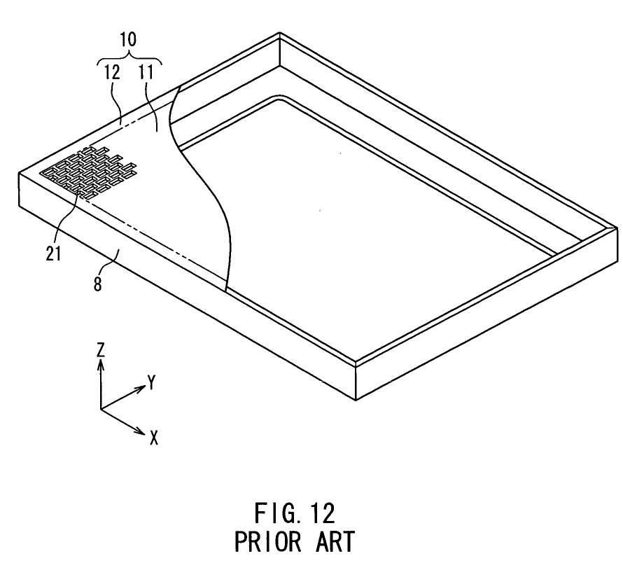

The basic configuration of a color cathode-ray tube of the present invention is not particularly limited except for a shadow mask, and may have a conventional general configuration as shown in FIG. 11, for example. Thus, the description of the entire configuration of the color cathode-ray tube will be omitted so as to avoid redundancy.

### Embodiment 1

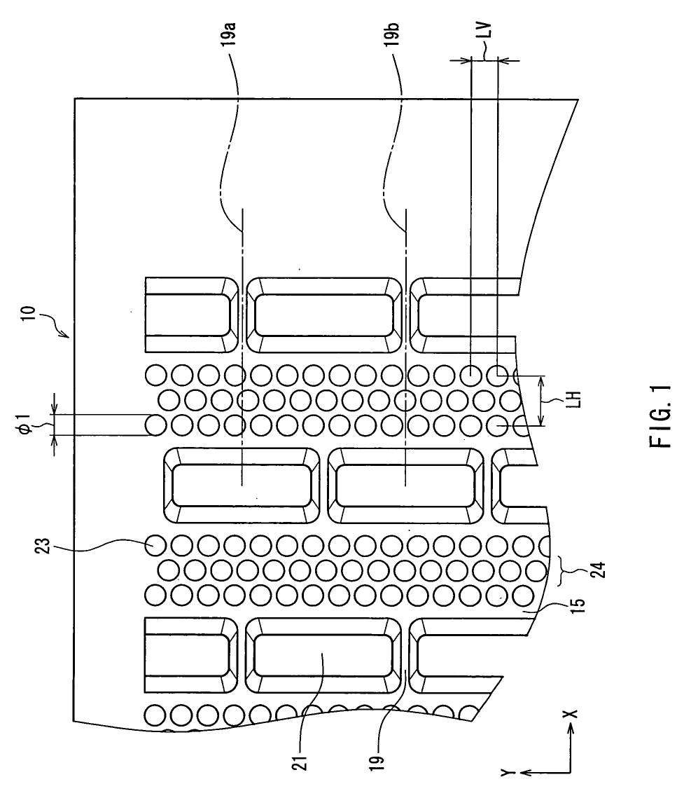

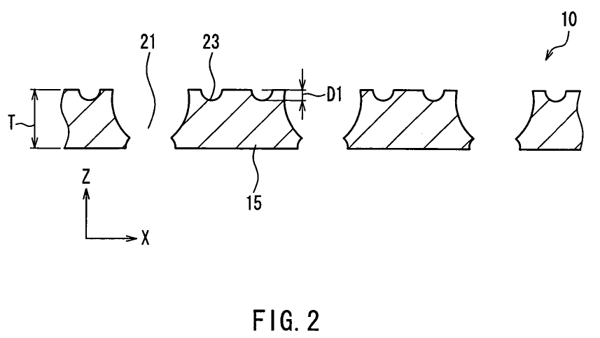

FIG. 1 is a partially enlarged front view of a shadow mask 10 of a color cathode-ray tube according to Embodiment 1 of the present invention, when seen from a panel 1 side. FIG. 2 is a partially enlarged end view of the shadow mask 10 of Embodiment 1 on a surface parallel to a long-side direction.

The shadow mask 10 has a plurality of tie-bands 15 in a strip shape with a longitudinal direction thereof being a short-side direction (Y-axis direction) of the shadow mask 10. The tie-bands 15 adjacent to each other in a long-side direction (X-axis direction) of the shadow mask 10 are connected to each other via a plurality of bridges 19. A plurality of electron beam passage apertures 21 are formed between the tie-bands 15 adjacent to each other in the X-axis direction. Then, a plurality of non-through concave portions 23 are formed on the surface of each tie-band 15 on a side opposed to the panel 10.

When a pair of straight lines 19a, 19b parallel to the X-axis direction, which respectively pass through a pair of the bridges 19 adjacent to each other in the Y-axis direction with the electron beam passage aperture 21 interposed therebetween, are defined, a plurality of the concave portions 23 are present in a region sandwiched by the pair of straight lines 19a, 19b on a surface of the tie-band 15 on a side opposed to the panel 10.

In each tie-band 15, the concave portions 23 are arranged regularly in the X-axis and Y-axis directions. Herein, “the concave portions 23 are arranged regularly in the X-axis direction (Y-axis direction)” means that at least two concave portions 23 are arranged at a constant period in a straight line parallel to the X-axis direction (Y-axis direction). A plurality of concave portions 23 arranged in a straight line parallel to the Y-axis direction form concave portion columns 24. In FIG. 1, three concave portion columns 24 are formed in one tie-band 15.

In each tie-band 15, the arrangement pitch of the two adjacent concave portions 23 placed in a straight line parallel to the X-axis direction is referred to as one-period distance LH in the X-axis direction, and the arrangement pitch of the two adjacent concave portions 23 placed in a straight line parallel to the Y-axis direction is referred to as one-period distance LV in the Y-axis direction. In the present embodiment, a relationship: LH ≈3^{0.5}×LV is satisfied. Furthermore, another concave portion 23 is present at a position away from one arbitrary concave portion 23 by about (½)×LH in the X-axis direction and about (½)×LV in the Y-axis direction.

Assuming that the depth of a deepest part of the concave portion 23 is D1, and the thickness of the shadow mask 10 is T, a relationship: 0.015 [mm]<D1<T/2 is satisfied.

The inner surface shape of the concave portion 23 may be a part of a sphere, and more specifically, may be a substantially semi-spherical shape.

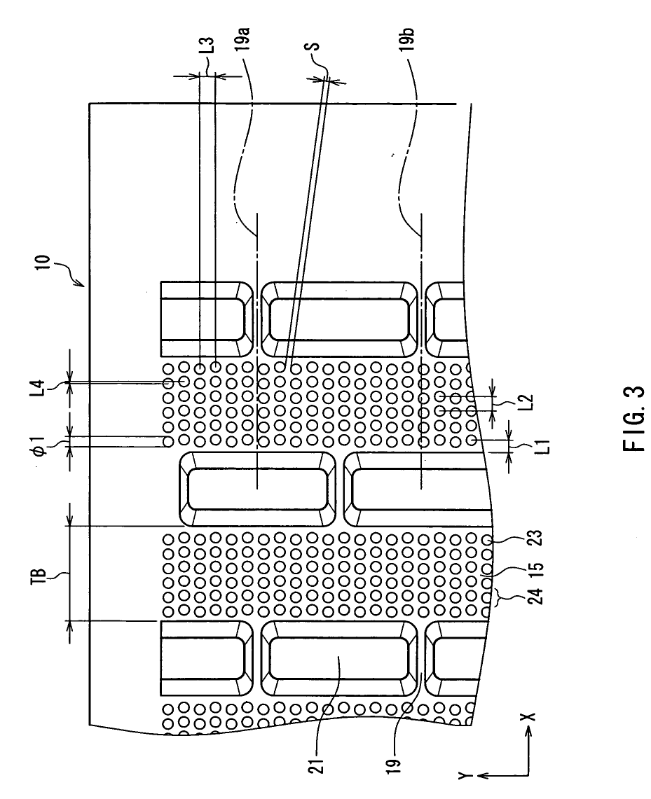

FIG. 3 is a partially enlarged front view of another shadow mask 10 of the color cathode-ray tube according to Embodiment 1 of the present invention, when seen from the panel 1 side. FIG. 3 is different from FIG. 1 in terms of the arrangement of the concave portions 23.

It is assumed that a width of the tie-band 15 in the long-side direction is TB, a diameter of the concave portion 23 is φ1, and a distance between the two closest concave portions 23 (i.e., the width of a non-concave region between the two closest concave portions 23) is S. The number n of the concave portions 23 arranged in a straight line parallel to the X-axis in each tie-band 15 is a maximum natural number that satisfies n≦(TB−S)(φ1+S). A distance L1 between an end of the tie-band 15 in the X-axis direction and a center of the concave portion 23 closest to the end substantially satisfies a relationship: L1=S+φ1/2. In the present embodiment, (TB−φ1−2S)/(n−0.5)−φ1−S≦0 is satisfied, and a distance L2 between centers of the concave portions 23 adjacent in the X-axis direction substantially satisfies a relationship: L2=(TB−φ1−2S)/(n−0.5). A distance L3 between centers of the two concave portions 23 whose positions in the Y-axis direction are different and which are closest to each other, and a distance L4 between these two concave portions 23 in the X-axis direction substantially satisfy relationships: L3=φ1+S, L4=TB−2S−φ1−L2 (n−1).

An example will be shown in which Embodiment 1 is applied to a color cathode-ray tube for a TV with a screen diagonal size of 51 cm.

An experiment was conducted for the purpose of confirming the effects of the color cathode-ray tube according to Embodiment 1 having the shadow mask 10 as shown in FIG. 3.

A metallic plate material (thickness T=0.220 mm) containing Fe as a main component was etched from both surfaces, whereby a plurality of electron beam passage apertures 21 that were through-holes were formed. Consequently, the tie-bands 15 in a strip shape placed at a constant interval in the X-axis direction and a plurality of bridges 19 connecting the tie-bands 15 adjacent to each other in the X-axis direction were formed concurrently. A width TB of the tie-band 15 in the X-axis direction was 0.444 mm. Furthermore, a plurality of concave portions 23 in a substantially semi-spherical shape (diameter) φ1=0.050 mm; depth D1=0.025 mm) were formed on the surface of each tie-band 15 on a side opposed to the panel 1 by half etching. In terms of the production, the distance S between the two concave portions 23 closest to each other was set to be 0.020 mm. In order to arrange the concave portions 23 at the highest density, the number n of the concave portions 23 arranged in the X-axis direction in each tie-band 15 was set to be 6, the distance L1 between the end of the tie-band 15 in the X-axis direction and the center of the concave portion 23 closest to the end was set to be 0.045 mm, and the distance L2 between the centers of the concave portions 23 adjacent to each other in the X-axis direction was set to be 0.070 mm, the distance L3 between the centers of the two concave portions 23 whose positions in the Y-axis direction were different and which were closest to each other was set to be 0.070 mm, and the distance L4 between these two concave portions 23 in the X-axis direction was set to be 0.004 mm. The concave portions 23 were formed only in the perforated region 11 in which the electron beam passage apertures 21 were formed. Owing to the formation of the concave portions 23, the surface area of the perforated region 11 was enlarged by about 10% compared with the case where the concave portions 23 were not formed. The metallic plate material processed as described above was formed in a dome-shaped curved surface with a surface on a side opposed to the panel 1 protruding by press forming using a die. Then, an electron-reflecting coating made of Bi₂O₃ was formed on a surface on a side where the concave portions 23 were not formed (a surface on a side opposed to the electron gun 4) by a well-known method of spraying a slurry containing Bi₂O₃ and water. Using the shadow mask 10 thus obtained, a color cathode-ray tube apparatus for a TV with a screen diagonal size of 51 cm was produced. This is assumed to be Example 1. In FIG. 3, 12 concave portion columns 24 are formed in one tie-band 15.

A color cathode-ray tube apparatus for a TV with a screen diagonal size of 51 cm was produced in the same way as in Example 1, except that the concave portions 23 were not formed on the metallic plate material. This is assumed to be Comparative Example 1.

A color cathode-ray tube apparatus for a TV with a screen diagonal size of 51 cm was produced in the same way as in Example 1, except that the same concave portions 23 as those in Example 1 were formed on the surface of each tie-band 15 on a side opposed to the electron gun 4, instead of the surface of each tie-band 15 on a side opposed to the panel 1, and the electron-reflecting coating made of Bi₂O₃ was not formed. This is assumed to be Comparative Example 2.

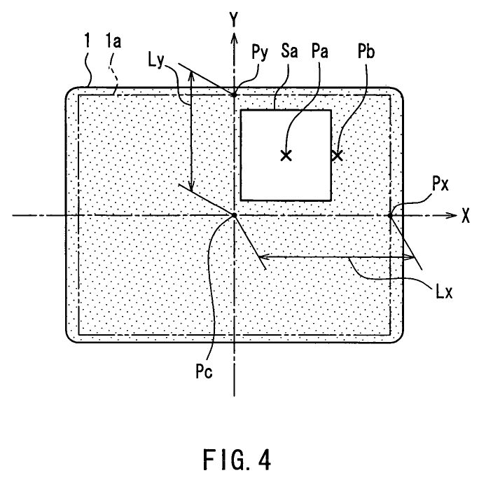

Regarding the color cathode-ray tube apparatuses of Example 1 and Comparative Examples 1 and 2, a shift amount hereinafter, referred to as a “landing movement amount”) of a position where an electron beam 5 strikes a phosphor screen 9 was measured. A measurement method is as follows. FIG. 4 is a front view of a useful display region 1a of the panel 1. It is assumed that a distance between a center Pc and an X-axis end Px of the useful display region 1a is Lx, and a distance between the center Pc and a Y-axis end Py thereof is Ly. A white display (hereinafter, referred to as a “display A”) was performed with an electron beam current of 230 μA only in a square region Sa whose center was positioned at a point Pa having an X-coordinate value of (⅓)×Lx and a Y-coordinate value of (½)×Ly with the center Pc being an origin and in which both an X-axis direction dimension and a Y-axis direction dimension were 110 mm, whereby the landing movement amount at the point Pa was measured. Similarly, a white display (hereinafter, referred to as a “display B”) was performed with an electron beam current of 230 μA only in a square region whose center was positioned at a point Pb having an X-coordinate value of (⅔)×Lx and a Y-coordinate value of (½)×Ly and in which both an X-axis direction dimension and a Y-axis direction dimension were 110 mm, whereby the landing movement amount at the point Pb was measured.

Table 1 shows the measurement results. Any of the displays A and B are represented by relative values with the measurement results in Comparative Example 1 being 100.

TABLE 1

| | Comparative | Comparative | |
|---|---|---|---|
| | Example 1 | Example 2 | Example 1 |
| Display A | 100 | 103 | 95 |
| Display B | 100 | 101 | 94 |

In any of the displays A and B, the landing movement amounts of Example 1 are smaller than those of Comparative Example 1. The reason for this is as follows. In Example 1, the surface area is enlarged by forming the concave portions 23 on the shadow mask 10, which increases a heat radiation amount to reduce a heat doming amount.

Furthermore, in any of the displays A and B, the landing movement amounts of Example 1 are smaller than those of Comparative Example 2. The reason for this is as follows. In Example 1, the reflection amount of electrons is increased owing to the formation of the electron-reflecting coating made of Bi₂O₃ on a surface of the shadow mask 10 on a side opposed to the electron gun 4, which reduces the heat energy absorption amount of the shadow mask 10 to reduce a heat doming amount.

As described above, according to Embodiment 1, a color cathode-ray tube can be provided, in which the problem of color displacement caused by heat doming of the shadow mask 10 is alleviated.

In Embodiment 1, although the concave portions 23 in a semi-spherical shape have been shown, the present invention is not limited thereto. The shape of the concave portions 23 seen from a direction normal to the shadow mask 10 may be oval or rectangular, or may be asymmetrical with respect to a center axis parallel to a normal line of the shadow mask 10.

Furthermore, the number n of the concave portions 23 arranged in the X-axis direction in one tie-band 15 is not limited to 2 or 6 as described above, and may be 1, 3, 4, 5, or 7 or more.

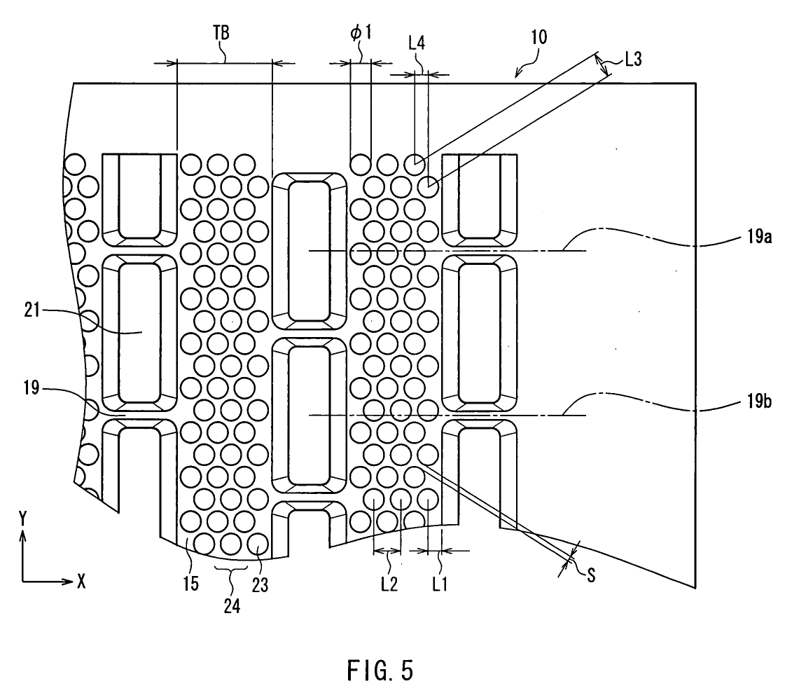

FIG. 5 is a partially enlarged front view of still another shadow mask 10 of the color cathode-ray tube according to Embodiment 1 of the present invention, when seen from the panel 1 side. FIG. 5 shows an example in which the concave portions 23 are arranged so as to satisfy L4≈L2/2 in FIG. 3. When the concave portions 23 are arranged as shown in FIG. 5, the distance in the Y-axis direction between two adjacent concave portions 23 arranged in a straight line parallel to the Y-axis direction can be decreased, so that the concave portions 23 can be arranged at the highest density. In FIG. 5, six concave portion columns 24 are formed in one tie-band 15.

### Embodiment 2

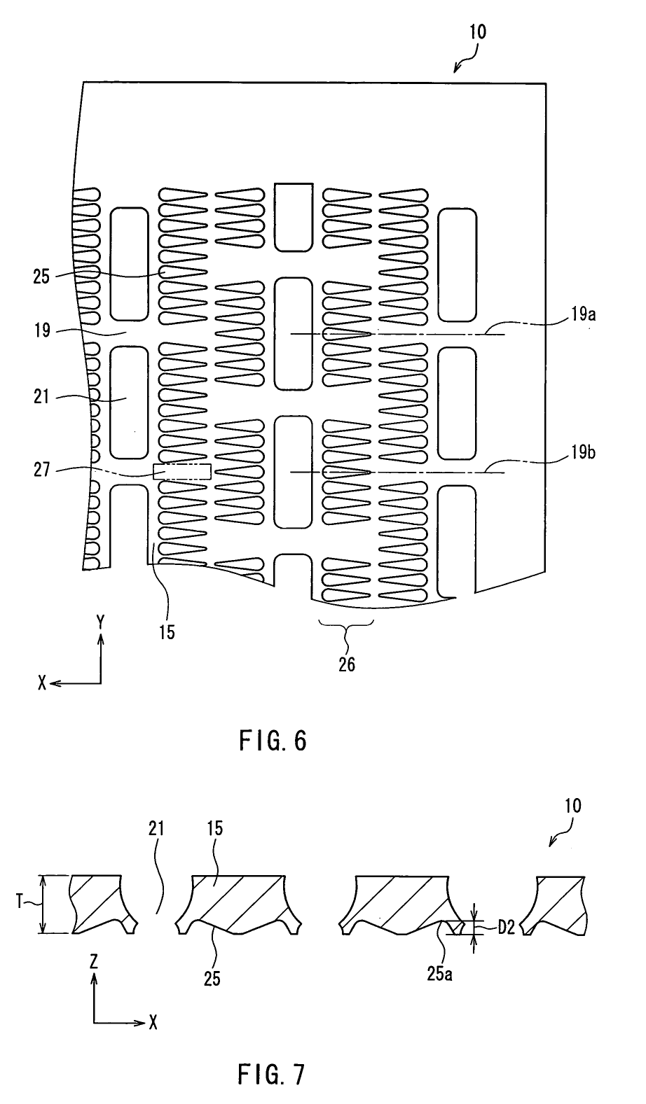

FIG. 6 is a partially enlarged front view of a shadow mask 10 of a color cathode-ray tube according to Embodiment 2 of the present invention, when seen from an electron gun 4 side. FIG. 7 is a partially enlarged end view of the shadow mask 10 of Embodiment 2 on a surface parallel to a long-side direction.

The shadow mask 10 has a plurality of tie-bands 15 in a strip shape with a longitudinal direction thereof being a short-side direction (Y-axis direction) of the shadow mask 10. The tie-bands 15 adjacent to each other in the long-side direction (X-axis direction) of the shadow mask 10 are connected to each other via a plurality of bridges 19. A plurality of electron beam passage apertures 21 are formed between the tie-bands 15 adjacent to each other in the X-axis direction. Then, a plurality of non-through concave portions 25 are formed on the surface of each tie-band 15 on a side opposed to the electron gun 4.

When a pair of straight lines 19a, 19b parallel to the X-axis direction, which respectively pass through a pair of the bridges 19 adjacent to each other in the Y-axis direction with the electron beam passage aperture 21 interposed therebetween, are defined, a plurality of concave portions 25 are present in a region sandwiched by the pair of straight lines 19a, 19b on a surface of the tie-band 15 on a side opposed to the electron gun 4.

In each tie-band 15, the concave portions 25 are arranged regularly in the X-axis and Y-axis directions. Herein, “the concave portions 25 are arranged regularly in the X-axis direction (Y-axis direction)” means that at least two concave portions 25 are arranged at a constant period on a straight line parallel to the X-axis direction (Y-axis direction). A plurality of concave portions 25 arranged in a straight line parallel to the Y-axis direction form concave portion columns 26. In the present embodiment, two concave portion columns 26 are formed in one tie-band 15.

The concave portion 25 is not formed at a position 27 adjacent to the bridge 19 in the X-axis direction.

When seen from a direction normal to the shadow mask 10, the concave portion 25 has an elongated groove shape, and the major axis direction thereof is matched with the X-axis direction. The width of the concave portion 25 in the Y-axis direction is largest at a position in the vicinity of an end on the electron beam passage aperture 21 side in the concave portion 25, and becomes smaller gradually from the above position to the center side of the tie-band 15 in the X-axis direction. Although the ratio of a size in the X-axis direction of the concave portion 25 with respect to the maximum width in the Y-axis direction thereof is not particularly limited, it preferably is, for example, 1.5 to 7.

The depth of the concave portion 25 is larger at the position in the vicinity of the end on the electron beam passage aperture 21 side in the concave portion 25, compared with the depth at the position in the vicinity of an end on the center side of the tie-band 15 in the concave portion 25, in the X-axis direction. More specifically, the depth of the concave portion 25 becomes larger gradually from the position in the vicinity of the end on the center side of the tie-band 15 in the concave portion 25 to the position in the vicinity of the end on the electron beam passage aperture 21 side in the concave portion 25, in the X-axis direction. Assuming that the depth of the concave portion 25 in a deepest part 25a in the vicinity of the end on the electron beam passage aperture 21 side in the concave portion 25 is D2, and the thickness of the shadow mask 10 is T, a relationship: D2<T/2 is satisfied.

The concave portions 25 can be formed, for example, by half-etching, using a mask having openings in which an opening width in the Y-axis direction is varied in the X-axis direction.

Results of an analysis performed so as to confirm the effects of the color cathode-ray tube according to Embodiment 2 having the shadow mask 10 as described above will be shown.

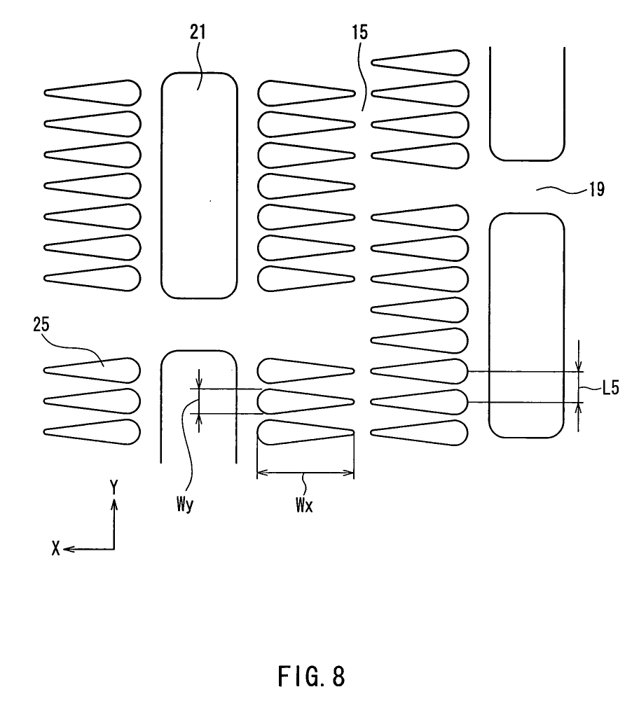

FIG. 8 is a partially enlarged front view of the shadow mask 10 corresponding to Embodiment 2 used for the analysis, when seen from the electron gun 4 side. The concave portion 25 was allowed to have a groove shape elongated in the X-axis direction, and the width thereof in the Y-axis direction was set to be largest at a position in the vicinity of an end on the electron beam passage aperture 21 side in the concave portion 25 and to become smaller gradually with distance from the position. An X-axis direction dimension Wx of the concave portion 25 was set to be 0.21 mm, and a Y-axis direction dimension Wy thereof was set to be 0.10 mm. Furthermore, the depth of the concave portion 25 was set to be largest at a position in the vicinity of an end on the electron beam passage aperture 21 side in the concave portion 25, and to become smaller gradually with distance from the position. A depth D2 in the deepest part 25a was set to be 0.05 mm, and a thickness T of the shadow mask 10 was set to be 0.22 mm. In each tie-band 15, concave portion columns 26 composed of a plurality of concave portions 25 arranged at a constant pitch (pitch L5=0.12 mm) in the Y-axis direction were arranged in two columns in the X-axis direction. The concave portions 25 were formed only in the perforated region 11 in which the electron beam passage apertures 21 were formed. Owing to the formation of the concave portions 25, the surface area of the perforated region 11 was enlarged by about 7%, compared with the case where the concave portions 25 were not formed. This is assumed to be Example 2.

In Comparative Example 3, concave portions in a substantially semi-spherical shape (diameter φ2=0.10 mm; depth D3=0.05 mm) were formed, instead of the elongated concave portions of Example 2. In each tie-band 15, concave portion columns composed of a plurality of concave portions arranged at a constant pitch (=0.12 mm) in the Y-axis direction were arranged in three columns at a constant pitch (=0.21 mm) in the X-axis direction. The concave portions were formed only in the perforated region 11 in which the electron beam passage apertures 21 were formed. Comparative Example 3 was set to be the same as Example 2, except for the shape and arrangement of the concave portions as described above.

A slurry containing Bi₂O₃ and water was sprayed onto the surface of each shadow mask 10 of Example 2 and Comparative Example 3 on which the concave portions were formed (surface on a side opposed to the electron gun 4), at a constant pressure in the normal direction from a position at a distance of 85 cm, and the flow of air on the surface was analyzed. Specifically, an average value of the velocity of air flow was calculated at a position away from the surface, on which the concave portions were formed, by 0.005 mm in the normal direction.

Consequently, an average value of the velocity of air flow at a position away from the surface of the shadow mask 10, on which the concave portions were formed, by 0.005 mm was 549 in Example 2, with the value in Comparative Example 3 being 100. In Example 2, in each tie-band 15, the concave portions 25 whose depth became larger gradually from the center to both side ends in the X-axis direction were formed, whereby the velocity of air flow in the vicinity of the surface of the tie-band 15 increased. Therefore, in Example 2, air containing Bi₂O₃ flows more into the concave portions 25, compared with Comparative Example 3, so that the electron-reflecting coating made of Bi₂O₃ can be formed even in the concave portions 25. Thus, the reflection amount of electron beams 5 increases, whereby the heat energy absorption amount of the shadow mask 10 decreases, with the result that the heat doming amount can be reduced.

As described above, according to Embodiment 2, in addition to the enlargement in the surface area of the shadow mask 10 ascribed to the formation of the concave portions 25, the electron-reflecting coating is likely to be formed even in the concave portions 25. Thus, the heat radiation amount of the shadow mask 10 and the reflection amount of electrons increase. Consequently, a color cathode-ray tube can be provided, in which the problem of color displacement caused by heat doming of the shadow mask 10 is alleviated.

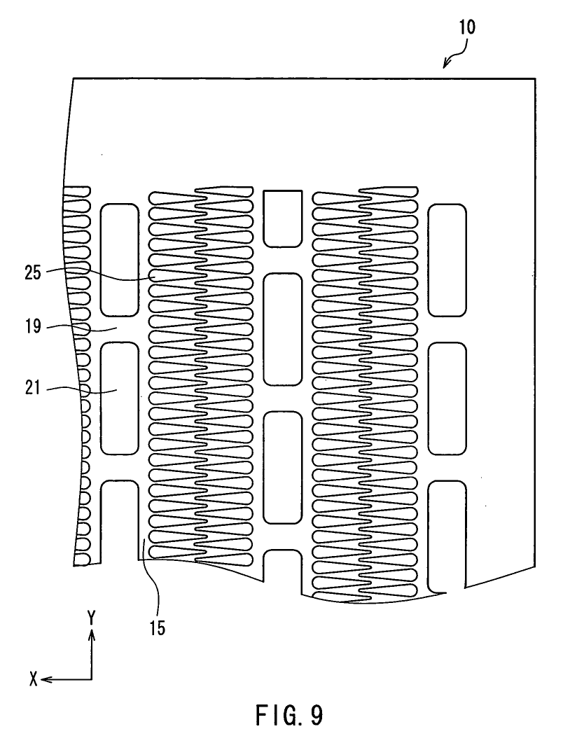

In the examples shown in FIGS. 6 to 8, the concave portions 25 are not formed in the vicinity of the center of each tie-band 15 in the X-axis direction. However, as shown in FIG. 9, the concave portions 25 may be formed in the vicinity of the center of each tie-band 15 in the X-axis direction. Because of this, the X-axis direction dimension of the concave portion 25 can be enlarged in the limited X-axis direction dimension of the tie-band 15. Therefore, the flow of air becomes more satisfactory in the vicinity of the surface of the tie-band 15 during spraying, and it becomes easier to form an electron-reflecting coating in the concave portions 25.

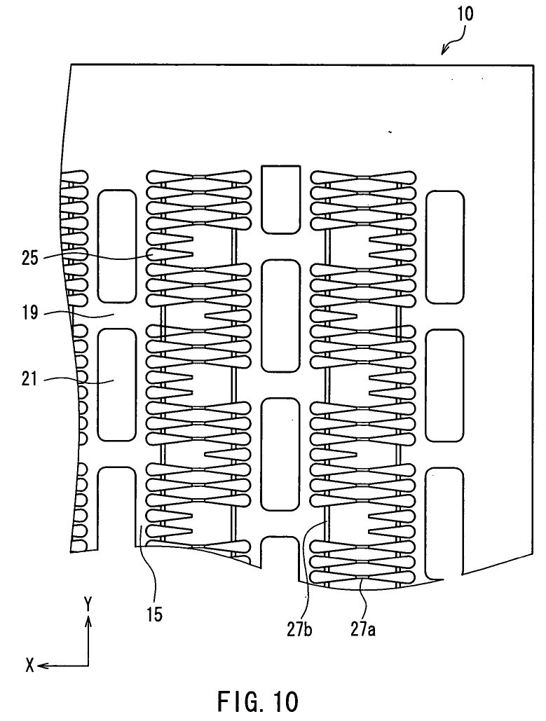

In the examples shown in FIGS. 6 to 9, the individual concave portions 25 are independent from each other. However, as shown in FIG. 10, the concave portions 25 adjacent to each other in the X-axis direction may be connected with first grooves 27a, and the concave portions 25 adjacent to each other in the Y-axis direction may be connected with second grooves 27b.

In Embodiments 1 and 2, the concave portions 23, 25 are formed over the entire area in the perforated region 11 of the shadow mask 10. However, the present invention is not limited thereto, and the concave portions 23, 25 may be formed only in a region where color displacement is caused by heat doming in the perforated region 11. Alternatively, the concave portions 23, 25 may be formed in a part or an entirety of the non-perforated region 12 as well as the perforated region 11.

On the surface of the shadow mask 10 on a side opposed to the panel 1, the concave portions 23 shown in Embodiment 1 may be formed, and on the surface on a side opposed to the electron gun 4, the concave portions 25 shown in Embodiment 2 may be formed.

In Examples 1, 2, the electron-reflecting coating is formed on a surface of the shadow mask 10 on a side opposed to the electron gun 4. However, the present invention can be applied even in the case where the electron-reflecting coating is not formed.

Although there is no particular limit to the applicable field of the invention, the heat radiation amount can be increased without degrading the electron reflection characteristics of a shadow mask 10, so that the present invention can be widely used as a color cathode-ray tube or the like, capable of performing a satisfactory color display.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A color cathode-ray tube, comprising: a panel; a funnel connected to the panel; an electron gun provided in a neck of the funnel; and a substantially rectangular shadow mask in a dome shape provided so as to be opposed to an inner surface of the panel,
wherein the shadow mask has a plurality of tie-bands with a longitudinal direction thereof being a short-side direction of the shadow mask, a plurality of bridges connecting the tie-bands adjacent to each other in a long-side direction of the shadow mask, and a plurality of electron beam passage apertures formed between the tie-bands adjacent to each other in the long-side direction, and
in a region sandwiched by a pair of straight lines parallel to the long-side direction, which respectively pass through a pair of the bridges adjacent to each other in the short-side direction, on a surface of the tie-band on a side opposed to the panel, a plurality of non-through concave portions are formed.

2. The color cathode-ray tube according to claim 1, wherein the concave portions are arranged regularly in at least one of the long-side direction and the short-side direction.

3. The color cathode-ray tube according to claim 1, wherein assuming that a depth of a deepest part of the concave portion is D1, and a thickness of the shadow mask is T, a relationship: 0.015 [mm]<D1<T/2 is satisfied.

4. The color cathode-ray tube according to claim 1, wherein the concave portion has a substantially semi-spherical shape.

5. The color cathode-ray tube according to claim 4, wherein assuming that a width of the tie-band in the long-side direction is TB, a diameter of the concave portion is φ1, and a distance between the two concave portions closest to each other is S,
a number n of the concave portions arranged in the long-side direction in the tie-band is a maximum natural number satisfying n≦(TB−S)/(φ1+S),
a distance L1 between an end of the tie-band in the long-side direction and a center of the concave portion closest to the end substantially satisfies a relationship: L1=S+φ1/2,
a distance L2 between centers of the concave portions adjacent to each other in the long-side direction substantially satisfies a relationship: L2=(TB−φ1−2S)/(n−0.5) when (TB−φ1−2S)/(n−0.5)−φ1−S≦0 is satisfied, and substantially satisfies a relationship: L2=φ1+S when (TB−φ1−2S)/(n−0.5)−φ1−S<0 is satisfied, and
a distance L3 between centers of the two concave portions whose positions in the short-side direction are different and which are closest to each other, and a distance L4 thereof in the long-side direction substantially satisfy relationships: L3=φ1+S and L4=TB−2S−φ1−L2 (n−1).

6. A color cathode-ray tube, comprising: a panel; a funnel connected to the panel; an electron gun provided in a neck of the funnel; and a substantially rectangular shadow mask in a dome shape provided so as to be opposed to an inner surface of the panel,
wherein the shadow mask has a plurality of tie-bands with a longitudinal direction thereof being a short-side direction of the shadow mask, a plurality of bridges connecting the tie-bands adjacent to each other in a long-side direction of the shadow mask, and a plurality of electron beam passage apertures formed between the tie-bands adjacent to each other in the long-side direction,
in a region sandwiched by a pair of straight lines parallel to the long-side direction, which respectively pass through a pair of the bridges adjacent to each other in the short-side direction, on a surface of the tie-band on a side opposed to the electron gun, a plurality of non-through concave portions are formed, and
a depth of the concave portion is larger at a position in a vicinity of an end on the electron beam passage aperture side in the concave portion, compared with a depth at a position in a vicinity of an end on a center side of the tie-band in the concave portion, in the long-side direction.

7. The color cathode-ray tube according to claim 6, wherein the concave portion is not formed at a position adjacent to the bridge in the long-side direction.

8. The color cathode-ray tube according to claim 6, wherein the concave portions are arranged regularly in the long-side direction and/or the short-side direction.

9. The color cathode-ray tube according to claim 6, wherein the concave portion is placed with a major axis direction thereof matched with the long-side direction, and a depth of the concave portion becomes larger gradually from the position in the vicinity of the end on the center side of the tie-band in the concave portion to the position in the vicinity of the end on the electron beam passage aperture side in the concave portion, in the long-side direction.

10. The color cathode-ray tube according to claim 6, wherein assuming that a depth of a deepest part of the concave portion is D2, and a thickness of the shadow mask is T, a relationship: D2<T/2 is satisfied.

11. The color cathode-ray tube according to claim 6, wherein a width of the concave portion in the short-side direction is larger at the position in the vicinity of the end on the electron beam passage aperture side in the concave portion, compared with a width at the position in the vicinity of the end on the center side of the tie-band in the concave portion, in the long-side direction.

12. The color cathode-ray tube according to claim 1, wherein a plurality of non-through second concave portions are formed in a region sandwiched by a pair of straight lines parallel to the long-side direction, which respectively pass through a pair of the bridges adjacent to each other in the short-side direction, on a surface of the tie-band on a side opposed to the electron gun, and
a depth of the second concave portion is larger at a position in a vicinity of an end on the electron beam passage aperture side in the second concave portion, compared with a depth at a position in a vicinity of an end on a center side of the tie-band in the second concave portion, in the long-side direction.

13. The color cathode-ray tube according to claim 1, comprising an electron-reflecting coating on a surface of the shadow mask on a side opposed to the electron gun.

14. The color cathode-ray tube according to claim 1, wherein the shadow mask is made of a material containing Fe as a main component.

15. The color cathode-ray tube according to claim 6, comprising an electron-reflecting coating on a surface of the shadow mask on a side opposed to the electron gun.

16. The color cathode-ray tube according to claim 6, wherein the shadow mask is made of a material containing Fe as a main component.
